(19) United States
(12) Patent Application Publication
(10) Pub. No.: US 2026/0023177 A1
(43) Pub. Date: Jan. 22, 2026

(54) SYSTEMS AND ASSEMBLIES FOR IMAGING AN UNDERWATER ENVIRONMENT

(71) Applicant: Navico Group Americas, LLC, Menomonee Falls, WI (US)

(72) Inventors: Jeremiah D. Clark, Tulsa, OK (US); Alan Proctor, Owasso, OK (US)

(21) Appl. No.: 19/209,352

(22) Filed: May 15, 2025

Related U.S. Application Data
(63) Continuation of application No. 18/776,406, filed on Jul. 18, 2024.

(51) Int. Cl. G01S 15/89; G01S 7/521; G01S 7/62; G01S 15/96

(52) U.S. Cl. CPC G01S 15/89; G01S 7/521; G01S 7/62; G01S 15/96

(57) ABSTRACT

An example system for a watercraft includes an outer shaft, an inner shaft, and a motor. The outer shaft is attached to a first sonar device. The inner shaft is disposed within the outer shaft and is rotatable with respect to the outer shaft. The inner shaft is attached to a second sonar device so as to enable directional control of a facing direction of the second sonar device relative to the outer shaft. The motor is coupled to the inner shaft and configured to operate to cause rotation of the inner shaft to cause rotation of the facing direction of the second sonar device. The first sonar device may be a 360-degree sonar imaging device, and the second sonar device may be a live sonar imaging device. The system may be mounted to a trolling motor or to the watercraft without mounting to the trolling motor.

### CROSS-REFERENCE TO RELATED APPLICATION(S)

This application claims priority to and is a continuation of U.S. patent application Ser. No. 18/776,406, entitled “SYSTEMS AND ASSEMBLIES FOR IMAGING AN UNDERWATER ENVIRONMENT”, filed Jul. 18, 2024, which is hereby incorporated by reference in its entirety.

### FIELD

Example embodiments of the present invention generally relate to sonar systems associated with watercrafts and, more particularly to systems and assemblies that enable maneuverability of sonar device(s) with respect to a watercraft.

### BACKGROUND

Many watercrafts used today have sonar devices that are mounted on poles and placed in the water to image the underwater environment. Such poles are typically mounted to the shaft of a trolling motor on the watercraft. This can lead to issues when a user needs to use the trolling motor for navigation or position keeping, while still needing to use the mounted sonar device to monitor a specific location or target within the underwater environment. While the trolling motor is being used for navigation or position keeping, the mounted sonar device will turn with the trolling motor, pointing to wherever the trolling motor is pointing and therefore not focusing on the specific location or target that the user needs to monitor. Other sonar devices that are mounted to trolling motor shafts operate by rotating a component of the sonar device, and such rotation can be difficult to manage while also using the trolling motor for navigation or position keeping purposes. Further, there are difficulties regarding utilizing different types of sonar devices together with or without trolling motor systems, particularly in a single device. Improvements in the foregoing are desired.

### BRIEF SUMMARY

The systems and assemblies disclosed herein allow for independent uses of multiple types of sonar devices, such as on a single device. Further, various systems and assemblies disclosed herein allow for independent uses of the trolling motor assembly and the sonar device assembly of an assembly. For example, some of the embodiments disclosed herein include an assembly that has a sonar device assembly and a trolling motor assembly. The sonar device assembly has an outer shaft and an inner shaft. The outer shaft is connected to a first sonar device, and the inner shaft is connected to a second sonar device. The inner shaft is disposed within the outer shaft and is rotatable with respect to the outer shaft via a motor that is coupled to the inner shaft. Rotation of the inner shaft by the motor causes rotation of the second sonar device. In some embodiments, the first sonar device is rotatable around the outer shaft. Further, in some embodiments, the entire sonar device assembly may be connected to the trolling motor assembly, and the connection may be such that the trolling motor can perform navigation or position keeping while the first sonar device and/or the second sonar device are independently operating. In other embodiments, the sonar device assembly may not be connected to the trolling motor assembly and may be instead connected to another type of assembly or to the watercraft directly (without any connection to any other type of assembly).

Such systems and assemblies are useful in that they enable sonar devices to function without interference from each other and in a single device. Also, the sonar devices function independently physically from a trolling motor while still allowing the trolling motor to fully function. Such systems and assemblies are also useful in that they still allow for the sonar device(s) and the trolling motor to be connected in a way that is compact and easy to handle even for novice users. For example, in some embodiments, a trolling motor assembly and a sonar device assembly may be stowable together and deployable together.

Some example embodiments of the disclosure may include various types of sonar devices. For example, a first sonar device may be a 360-degree sonar imaging device, and a second sonar device may be a live sonar imaging device. However, other types of sonar devices are also contemplated, such as a 360-degree live sonar imaging device.

Some example embodiments may employ only one sonar device, such as a 360-degree sonar image device, such as on a stand-alone shaft. Such a shaft may be hollow to enable it to be positioned over another shaft, such as a sonar pole or other device with a shaft.

In some embodiments, a user may provide user input to a sonar image and the steerable sonar device may be steering to cover that indicated position. For example, a user may point to a spot on a 360 sonar image, and the steerable live sonar device may be steered such that the live sonar coverage is aimed at that spot in the real world.

In an example embodiment, a system for a watercraft is provided. The system comprises an outer shaft, with the outer shaft being attached to a first sonar device. The system further includes an inner shaft that is disposed within the outer shaft and that is rotatable with respect to the outer shaft. The inner shaft is attached to a second sonar device so as to enable directional control of a facing direction of the second sonar device relative to the outer shaft. The system further includes a motor coupled to the inner shaft and configured to operate to cause rotation of the inner shaft to cause corresponding rotation of the facing direction of the second sonar device.

In some embodiments, the outer shaft is fixed with respect to a base component, and wherein the base component comprises the motor that is coupled to the inner shaft. In some embodiments, the base component comprises an indicator indicating the facing direction of the second sonar device. In some embodiments, the base component further comprises a second indicator indicating a second facing direction of the first sonar device.

In some embodiments, the first sonar device is a 360-degree sonar imaging device. In some embodiments, the 360-degree sonar imaging device comprises at least one sonar transducer element. In some embodiments, the 360-degree sonar imaging device comprises three linear sonar transducer elements. In some embodiments, a conical or square transducer element is paired with each of the three linear sonar transducer elements, and wherein each of the conical or square transducer elements is used to create fish arches for sonar imagery for the linear transducer element with which the conical or square transducer element is paired.

In some embodiments, the 360-degree sonar imaging device is attached circumferentially around the outer shaft.

In some embodiments, the system further comprises a second motor coupled to the 360-degree sonar imaging device that is configured to cause each linear transducer element of the 360-degree sonar imaging device to adjust a facing direction along an arc of angles about the outer shaft in a back and forth manner. In some embodiments, the second motor causes the facing direction of each linear transducer element of the 360-degree sonar imaging device to adjust between a 0-degree reference point and a point that is 120 degrees from the 0-degree reference point. In some embodiments, the 360-degree sonar imaging device is configured to produce a 360-degree sonar image of an underwater environment beneath the system.

In some embodiments, the 360-degree sonar imaging device provides live or near-live sonar imagery such that an entirety of a resulting image is continuously updated.

In some embodiments, the system is configured such that a vertical distance between the first sonar device and the second sonar device is such that the second sonar device does not hinder a first imaging volume of the first sonar device and such that the first sonar device does not hinder a second imaging volume of the second sonar device.

In some embodiments, the inner shaft, the outer shaft, the first sonar device, and the second sonar device are configured to be stowable in the watercraft together and are configured to be deployable from the watercraft together.

In some embodiments, the second sonar device is pivotable with respect to the inner shaft within a vertical plane.

In some embodiments, the second sonar device is a live sonar imaging device that provides live or near-live sonar imagery such that an entirety of a resulting image is continuously updated. In some embodiments, the live sonar imaging device comprises three sonar transducer arrays.

In some embodiments, a trolling motor system is at least partially connected to the outer shaft via one or more support arms. In some embodiments, a trolling motor shaft corresponding to a trolling motor of the trolling motor system and the inner shaft can rotate independently of each other. In some embodiments, the trolling motor system and the inner shaft are configured to rotate such that rotations of the trolling motor system and the inner shaft correspond to each other.

In some embodiments, the system further comprises a display; one or more processors; and a memory including computer program code. The computer program code is configured to, when executed, cause the one or more processors to: generate a first sonar image based on first sonar data from the first sonar device; generate a second sonar image based on second sonar data from the second sonar device; cause presentation of the first sonar image and the second sonar image; receive user input directed to a position within the first sonar image; determine the position; determine a direction to face the second sonar device so as to cause sonar coverage from the second sonar device to cover the determined position; and cause the motor to operate to cause the second sonar device to adjust the facing direction such that the sonar coverage from the second sonar device covers the determined position.

In another example embodiment, a system for a watercraft is provided. The system comprises an outer shaft, with the outer shaft being attached to a first sonar device, and wherein the first sonar device is rotatable. The system comprises an inner shaft that is disposed within the outer shaft and that is rotatable with respect to the outer shaft. The inner shaft is attached to a second sonar device so as to enable directional control of a facing direction of the second sonar device relative to the outer shaft. The first sonar device and the second sonar device are configured to rotate independently of each other.

In yet another example embodiment an assembly for a watercraft is provided. The assembly comprises an outer shaft, with the outer shaft being attached to a first sonar device, and wherein the first sonar device is a 360-degree sonar imaging device. The assembly further comprises an inner shaft that is disposed within the outer shaft and that is rotatable with respect to the outer shaft. The inner shaft is attached to a second sonar device so as to enable directional control of a facing direction of the second sonar device relative to the outer shaft. The second sonar device is a live sonar imaging device that provides live or near-live sonar imagery such that an entirety of a resulting image is continuously updated. The assembly further includes a motor coupled to the inner shaft and configured to operate to cause rotation of the inner shaft to cause rotation of the facing direction of the second sonar device.

In various embodiments, corresponding methods of use and/or manufacturing are also contemplated.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates an example watercraft with an assembly that includes a trolling motor assembly and a sonar device assembly, the assembly being deployed, in accordance with some embodiments described herein;

FIG. 2 illustrates the watercraft of FIG. 1 with the assembly being stowed, in accordance with some embodiments described herein;

FIG. 3 illustrates an isolated view of the assembly of FIGS. 1-2, in accordance with some embodiments discussed herein;

FIG. 4 illustrates an isolated view of the sonar device assembly of the assembly of FIGS. 1-3, the sonar device assembly including a first sonar device and a second sonar device, in accordance with some embodiments discussed herein;

FIG. 5 illustrates another example sonar device assembly, the sonar device assembly including a first sonar device and a second sonar device, in accordance with some embodiments discussed herein;

FIG. 6A is a display showing a 360-degree sonar image on the left and a live sonar image on the right, in accordance with some embodiments discussed herein;

FIG. 6B is a display showing the 360-degree sonar image on the left with a user pointing to a position within the image, and accordingly, the live sonar coverage is steered toward that position in the real-world, in accordance with some embodiments discussed herein;

FIG. 7A illustrates a zoomed-in top perspective view of the first sonar device of FIG. 5, in accordance with some embodiments discussed herein;

FIG. 7B illustrates a zoomed-in bottom perspective view of the first sonar device of FIGS. 5 and 7A, in accordance with some embodiments discussed herein;

FIG. 8 illustrates the first sonar device of FIGS. 5 and 7A-7B, the first sonar device having three linear sonar transducer elements, in accordance with some embodiments discussed herein;

FIG. 9 is a 360-degree sonar image that may be created using the linear sonar transducer elements of FIG. 8 according to a buildup pattern illustrated thereon, in accordance with some embodiments discussed herein;

FIG. 10 illustrates the first sonar device of FIGS. 5 and 7A-8, the first sonar device having three linear sonar transducer elements and three conical or square transducer elements, in accordance with some embodiments discussed herein;

FIG. 11 is a 360-degree sonar image created using the linear sonar transducer elements and the conical or square transducer elements of FIG. 8, in accordance with some embodiments discussed herein;

FIG. 12 illustrates a navigation configuration for an example assembly, in accordance with some embodiments discussed herein;

FIG. 13 illustrates another example sonar device assembly, the sonar device assembly including a first sonar device and a second sonar device, in accordance with some embodiments discussed herein;

FIG. 14 is a block diagram of an example system, in accordance with some embodiments described herein;

FIG. 15 shows an example method for forming a 360-degree sonar image, in accordance with some embodiments discussed herein; and

FIG. 16 shows an example method for forming and updating a live sonar image, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

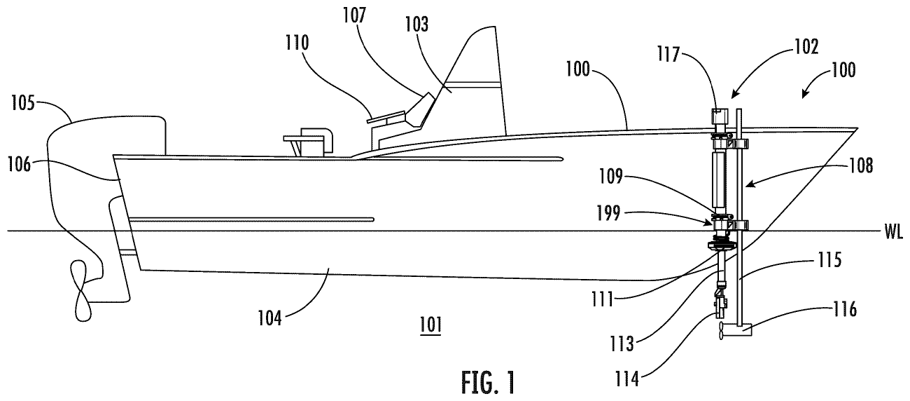

FIG. 1 illustrates a surface watercraft 100 on a body of water 101. The watercraft includes a marine electronic device 107 such as may be utilized by a user to interact with, view, or otherwise control various aspects of the watercraft and its various marine systems described herein. In the illustrated embodiment, the marine electronic device 107 is positioned proximate a console 103 of the watercraft 100-although other places on the watercraft 100 are contemplated. Likewise, additionally or alternatively, a user's mobile device may include functionality of a marine electronic device.

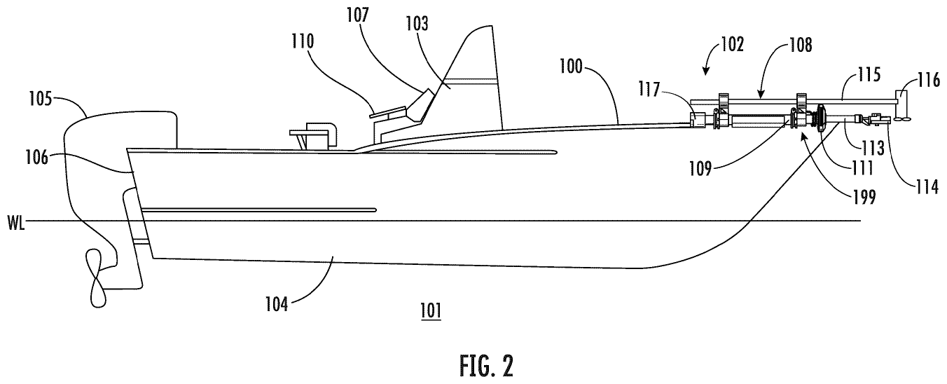

Depending on the configuration, the watercraft 100 may include a main propulsion motor 105, such as an outboard or inboard motor, at, e.g., the stern 106 of the watercraft 100. Additionally, the watercraft 100 may include a trolling motor configured to propel the watercraft 100 or maintain a position. The watercraft 100 may also include one or more sonar devices that each include one or more transducer assemblies configured to image the underwater environment beneath the watercraft 100. In the embodiment shown in FIG. 1, an assembly 102 includes a sonar device assembly 199 and a trolling motor assembly 108, which are shown in FIG. 1 as being connected. It should be appreciated, however, that in other embodiments, the sonar device assembly 199 may not be connected to the trolling motor assembly 108, and may instead be connected to a different type of assembly, or to the watercraft 100 directly. In FIG. 1, the assembly 102 is shown in a deployed position (e.g., such that a propeller portion 116 of the trolling motor assembly 108 and a first sonar device 111 and a second sonar device 114 are beneath the waterline WL of the body of water 101). In FIG. 2, the assembly 102 is shown in a stowed position (e.g., such that the propeller portion 116 of the trolling motor assembly 108 and the first sonar device 111 and the second sonar device 114 are not beneath the waterline WL of the body of water 101 and are secured in the watercraft). Notably, although the sonar device assembly 199 and the trolling motor assembly 108 are able to be stowed together and deployed together, each of the sonar device assembly 199 and the trolling motor assembly 108 can be controlled and operated independently such that one does not interfere with the other during (e.g., simultaneous) use.

The trolling motor assembly 108 includes a shaft 115 and the propeller portion 116. The sonar device assembly 199 includes an outer shaft 109 and an inner shaft 113, and the inner shaft 113 is disposed within the outer shaft 109. The outer shaft 109 is attached to a first sonar device 111, and the inner shaft 113 is attached to a second sonar device 114. The inner shaft 113 is rotatable with respect to the outer shaft 109 such as to enable directional control of a facing direction of the second sonar device 114 relative to the outer shaft 109. A base component 117 comprises a first motor coupled to the inner shaft 113 and operates to cause rotation of the inner shaft 113 and therefore rotation of the second sonar device 114.

Sonar transducer assemblies incorporated within the sonar device assembly 199 may be configured to transmit signals into the underwater environment and receive sonar return data generated by receipt of sonar return signals. A processor may then generate, based on the sonar return data, sonar image data corresponding to generation of at least one sonar image of the underwater environment. The sonar data and/or image(s) that are generated may then be displayed on a screen of a marine electronic device such as the marine electronic device 107.

The motor 105 and/or the trolling motor assembly 108 may be steerable using a steering wheel 110, or in some embodiments, the watercraft 100 may have a navigation assembly that is operable to steer the motor 105 and/or the trolling motor 108. The navigation assembly may be connected to a processor and/or be within a marine electronic device 107, or it may be located anywhere else on the watercraft 100. Alternatively, the processor may be located remotely.

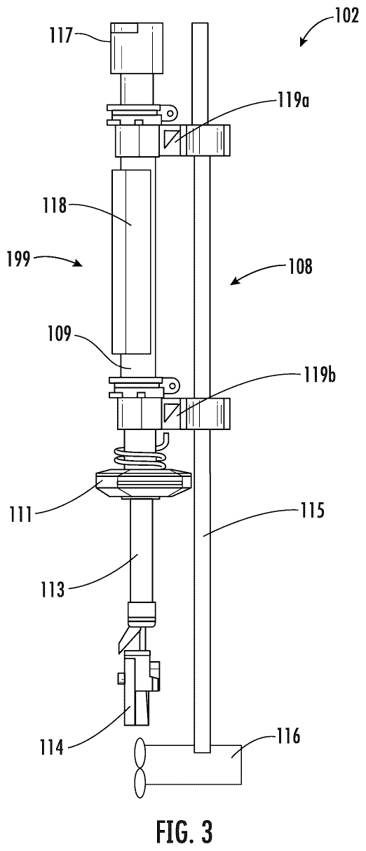

FIG. 3 illustrates an isolated view of the assembly 102, which includes the sonar device assembly 199 and the trolling motor assembly 108. Although the sonar device assembly 199 and the trolling motor assembly 108 are joined together at the top of the assembly 102 in FIG. 3, it should be appreciated that, in other embodiments, the sonar device assembly 199 may stand alone or be connected to any other type of assembly. As explained with reference to FIGS. 1-2, the trolling motor assembly 108 includes the shaft 115 and the propeller portion 116. The sonar device assembly 199 includes the inner shaft 113 disposed within the outer shaft 109, and the outer shaft 109 is fixed with respect to the base component 117. The outer shaft is attached to the first sonar device 111, and the inner shaft is attached to the second sonar device 114. The inner shaft 113 is rotatable with respect to the outer shaft 109 so as to enable directional control of a facing direction of the second sonar device 114 relative to the outer shaft 109.

In some embodiments, either the base component 117 of the sonar device assembly 199 may include a first motor coupled to the inner shaft 113. The first motor may operate to cause rotation of the inner shaft 113 and therefore rotation of the second sonar device 114. Such rotation may be caused, for example, by signals sent from a device such as a marine electronic device and may enable a user to control a facing direction of the second sonar device 114.

In some embodiments, the sonar device assembly 199 may be connected to the trolling motor assembly 108 via a first support arm 119a and a second support arm 119b. Such connection may, in some embodiments, allow independent rotation of the shaft 115 of the trolling motor assembly 108. It should be appreciated that the first support arm 119a and the second support arm 119b may be optional and that any other connection method is contemplated within the scope of this disclosure. Further, in some other embodiments, the sonar device assembly 199 may not be connected to the trolling motor assembly 108 at all.

The sheath 118 may be used to more easily stow the assembly 102 (e.g., as shown in FIG. 2). For example, the sheath 118 may be configured to snap or otherwise attach to another component on the watercraft to keep the assembly 102 in a stowed position when desired. It should be appreciated that the sheath 118 is optional, and that other stowing components and methods are also contemplated within the scope of this disclosure.

In some embodiments, the shaft 115 of the trolling motor assembly 108 and the inner shaft 113 of the sonar device assembly 199 are configured to be able to rotate independently of each other. For example, the assembly 102 may be configured such that the first sonar device 111 and the second sonar device 114 are usable in any direction while the propeller portion 116 of the trolling motor assembly 108 is being steered by the shaft 115 in any direction. This is in contrast to many previous solutions, which require a user to cease use of a trolling motor in order to steer a connected sonar device (or at least require the user to sync the direction of the trolling motor with the direction of the sonar device when the sonar device is used). Additionally or alternatively, in some further embodiments, the shaft 115 of the trolling motor assembly 108 and the inner shaft 113 of the sonar device assembly 199 may be configured to rotate such that rotations of the shaft 115 of the trolling motor assembly 108 and the inner shaft 113 of the sonar device assembly 199 correspond to each other. For example, if a user decides that he or she wants to image the underwater environment in the same changing direction as the changing direction of the propeller portion 116 of the trolling motor assembly 108, some embodiments may allow the user to sync the shaft 115 of the trolling motor assembly 108 and the inner shaft 113 of the sonar device assembly 199 either mechanically or through use of a connected device such as a marine electronics device. Other configurations are also contemplated within the scope of this disclosure.

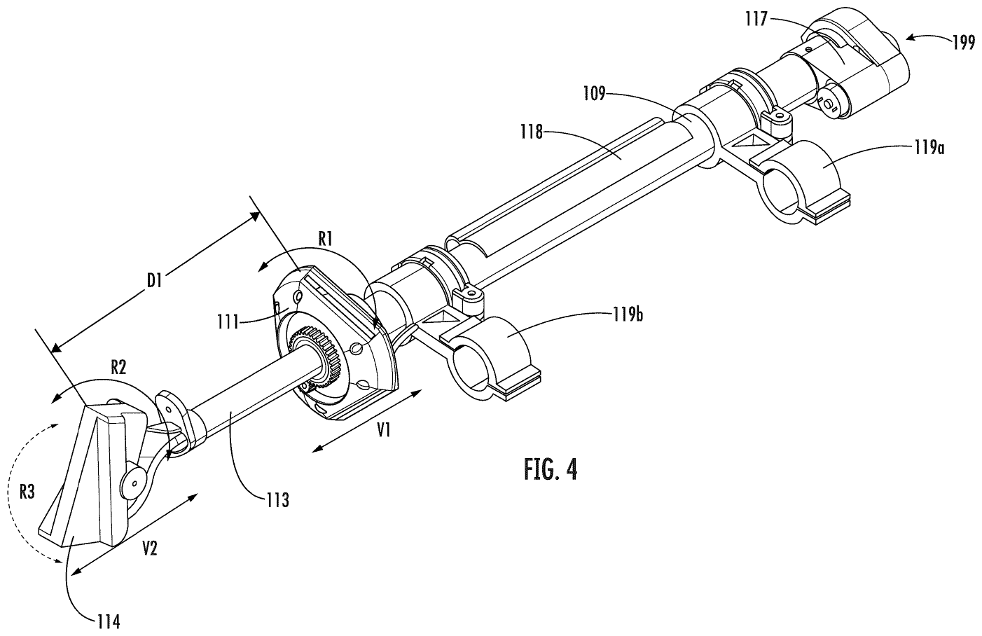

FIG. 4 illustrates an isolated view of the sonar device assembly 199 of the assembly 102. As described above, the sonar device assembly 199 may include the top portion 117, the outer shaft 109, the inner shaft 113, the first sonar device 111, the second sonar device 114, the sheath 118, the first support arm 119a and the second support arm 119b, among other components. It is noted that some of these components may be optional, such as the sheath 118. The sonar device assembly 199 may be configured such that a first motor coupled to the inner shaft 113 causes rotation of the inner shaft 113 and therefore rotation of the second sonar device 114. Additionally, the first sonar device 111 may be, in some embodiments, rotatable around the outer shaft 109 via a second motor that is coupled to the first sonar device 111.

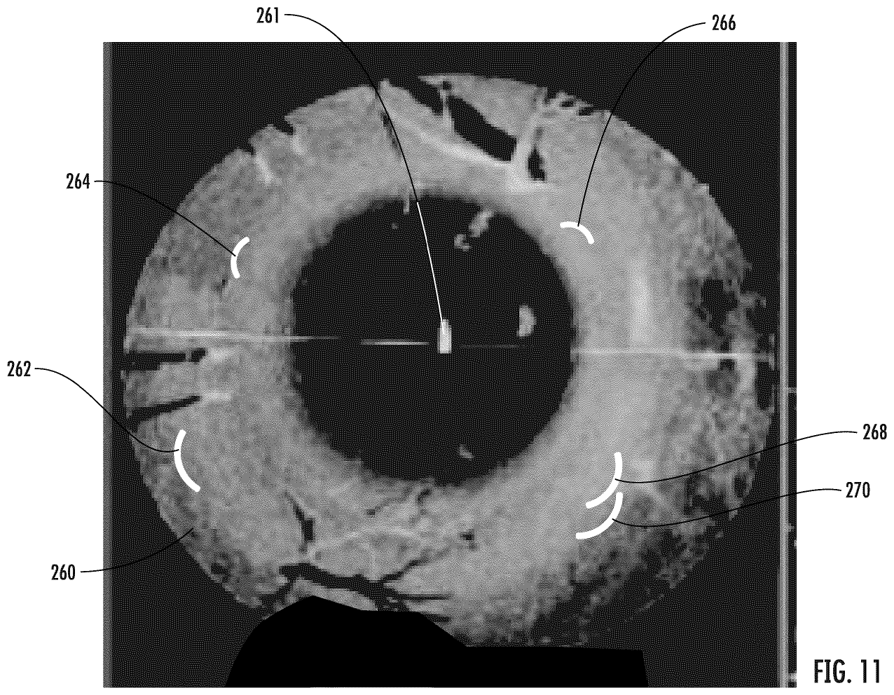

In the embodiment shown, the first sonar device 111 is a 360-degree sonar imaging device. In some embodiments, the 360-degree sonar imaging device (e.g., the first sonar device 111) includes three linear sonar transducer elements, and in some further embodiments, a conical or square transducer element may be paired with each of the three linear sonar transducer elements. As will be described in more detail below with reference to FIGS. 10-11, each of the conical or square transducer elements may be used to create fish arches for sonar imagery for the linear transducer element with which the conical or square transducer element is paired. As shown in FIG. 4, the first sonar device 111 is attached circumferentially around the outer shaft 109 and is rotatable along a path RI around the outer shaft 109. The first sonar device 111 may also be adjustable along the outer shaft 109 along a vertically aligned axis V1. It should be appreciated that, although the first sonar device 111 is shown as being rotatable around the outer shaft 109 in FIG. 4, that in other embodiments, the first sonar device 111 may be rotatable around the inner shaft 113 and/or may be adjustable along the inner shaft 113 and/or the outer shaft 109 along the vertically aligned axis V1. In either case, movement of the first sonar device 111 may be via a second motor that is coupled to the first sonar device 111. Further, in some other embodiments, the first sonar device 111 (which may or may not be a 360-degree sonar imaging device) may be stationary and therefore non-rotatable around the inner shaft 113 and/or the outer shaft 109. The first sonar device 111 may also, in other embodiments, have any other number of sonar transducer elements or arrays. Other configurations are also contemplated within the scope of this disclosure.

In embodiments in which the first sonar device 111 is a 360-degree sonar imaging device and is rotatable via the second motor, the second motor may be configured to cause each linear transducer element of the 360-degree sonar imaging device to adjust a facing direction along an arc of angles about the outer shaft 109 in a back-and-forth manner. For example, the second motor may cause the facing direction of each linear transducer element of the 360-degree sonar imaging device to adjust between a 0-degree reference point and a point that is 120 degrees from the 0-degree reference point. The 360-degree sonar imaging device may thus be configured to produce a 360-degree sonar image of an underwater environment beneath the sonar device assembly 199 built up of the three portions of 120-degrees of sonar imagery.

In the embodiment shown in FIG. 4, the second sonar device 114 is a live sonar imaging device that includes three sonar transducer arrays. As shown, the second sonar device 114 may be pivotable with respect to the inner shaft 113 within a vertical plane along path R2 and may also be movable via up-and-down movement of the inner shaft 113 along vertical axis V2. In some further embodiments, the second sonar device 114 may also be pivotable with respect to the inner shaft 113 within a horizontal plane along path R3. Such pivoting may be accomplished using a third motor that is attached to the second sonar device 114. For example, the third motor may be controlled by a processor which can direct the third motor to cause the second sonar device 114 to move along one or both of paths R2 and/or R3.

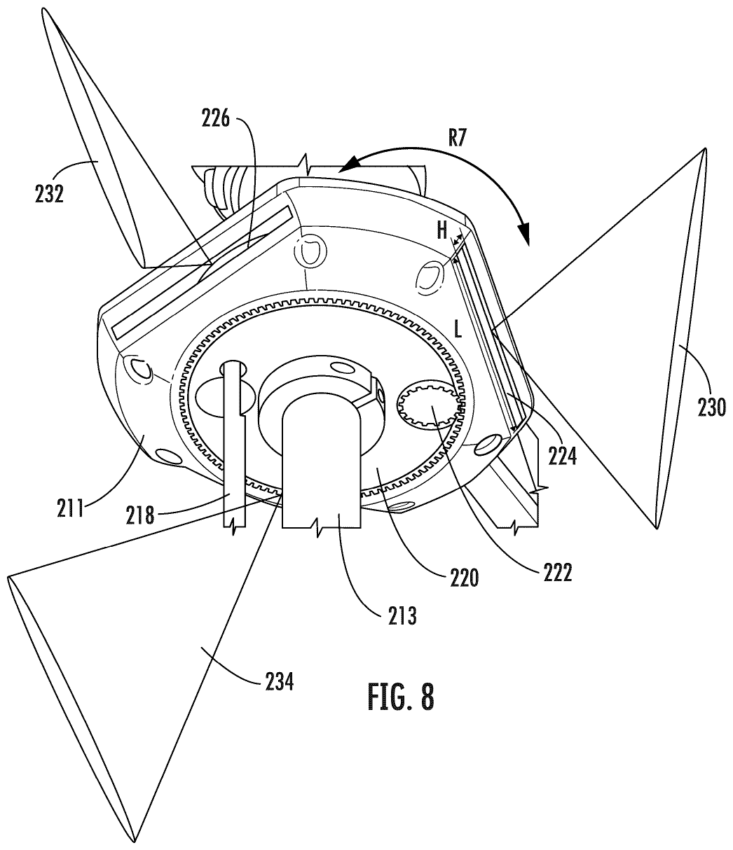

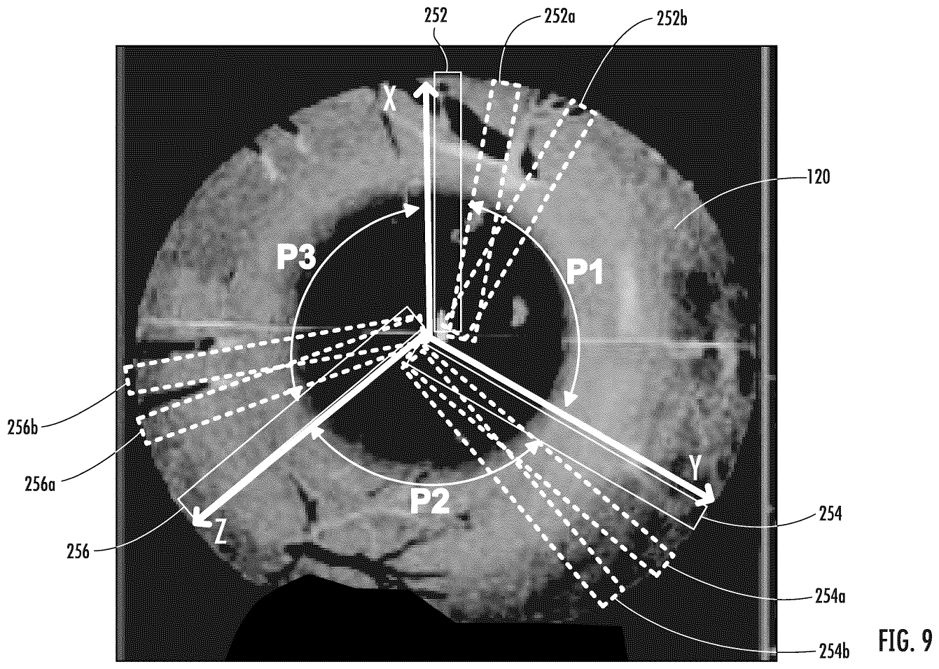

The sonar device assembly 109 may be configured such that a vertical distance DI between the first sonar device 111 and the second sonar device 114 is such that the second sonar device 114 does not hinder a first imaging volume of the first sonar device 111 and such that the first sonar device 111 does not hinder a second imaging volume of the second sonar device 114. That is, the first sonar device 111 and the second sonar device 114 may be positioned and/or may be adjustable such that images produced by each are not hindered by each other. For example, the vertical distance DI may be enough such that the second sonar device 114 does not intersect with the beams emitted by the transducer elements of the first sonar device 111, which may be emitted in an outward and downward direction (e.g., see FIG. 8). This may be accomplished by movement of one or both of the first sonar device 111 along the first vertical axis VI or the second sonar device 114 along the second vertical axis V2. As another example, the second sonar device 114 may, in some embodiments, have a length that is longer than its width, while the first sonar device 111 may have a triangular-like shape (as shown). In such a case, it may be desirable to move the second sonar device 114 along one or both of the radial path R2 or the radial path R3 (in addition to or as an alternative to moving one or both of the first sonar device 111 along the first vertical axis VI or the second sonar device 114 along the second vertical axis V2) to ensure that the second sonar device 114 does not intersect with the beams emitted by the transducer elements of the first sonar device 111.

It should be appreciated that, although the first sonar device 111 in FIG. 4 is a 360-degree sonar imaging device and the second sonar device 114 in FIG. 4 is a live sonar imaging device, in other embodiments, the first sonar device 111 and the second sonar device 114 may be any other type of sonar device. Further, the sonar device assembly 199 may include more or less sonar devices than shown in FIG. 4, and the one or more sonar devices may be configured differently, e.g., depending on the type of sonar device. For example, in some embodiments, the first sonar device 111 may be attached to a shaft that is mountable on its own. In this regard, the shaft may provide, for example, 360-degree sonar imaging apart from other sonar. As another example, the first sonar device 11 may be attached to a shaft that is position able over any other shaft, e.g., as a sleeve. In this way, 360-degree sonar imaging can be added to any other shaft/pole apparatus.

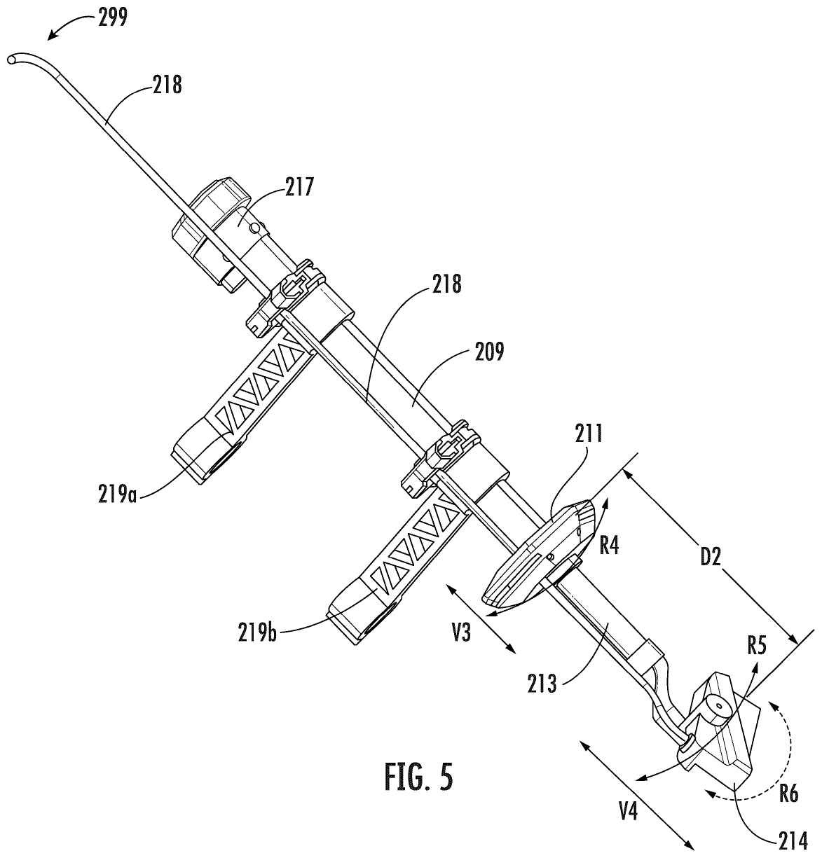

FIG. 5 illustrates an isolated view of another example sonar device assembly 299. Similar to the sonar device assembly 199 described above, the sonar device assembly 299 may include a base component 217, an outer shaft 209, an inner shaft 213, a first sonar device 211, a second sonar device 214, a first support arm 219a, and a second support arm 219b. The sonar device assembly 299 may be configured such that a first motor coupled to the inner shaft 213 causes rotation of the inner shaft 213 and therefore rotation of the second sonar device 214. Additionally, the first sonar device 211 may be, in some embodiments, rotatable around the outer shaft 209 via a second motor that is coupled to the first sonar device 211.

As shown in FIG. 5, the first support arm 219a and the second support arm 219b are longer than the first support arm 119a and the second support arm 119b shown in FIG. 4. This may be desirable, for example, in embodiments in which the sonar device assembly 299 is being paired with a trolling motor assembly with a larger trolling motor propellor (or for any other reason in which more spacing between the sonar device assembly 299 and the trolling motor assembly is desired). Any length of the first support arm 219a and/or the second support arm 219b is contemplated within the scope of this disclosure. Such lengths may be determined based on a variety of factors, such as the dimensions of the watercraft on which the assembly is being installed and/or a predicted interference radius of one or both of the first sonar device 211 and/or the second sonar device 214 (e.g., to ensure that the trolling motor assembly does not interfere with images produced using the first sonar device 211 and/or the second sonar device 214). Further, it should be appreciated that the first support arm 219a and the second support arm 219b may not be included at all. For example, in some embodiments, any other connection mechanism may be used to connect the sonar device assembly 299 with a trolling motor assembly, or the sonar device assembly 299 may not be connected to a trolling motor assembly at all.

In the embodiment shown, the first sonar device 211 is a 360-degree sonar imaging device. In some embodiments, the 360-degree sonar imaging device (e.g., the first sonar device 211) includes three linear sonar transducer elements, and in some further embodiments, a conical or square transducer element may be paired with each of the three linear sonar transducer elements. As will be described in more detail below with reference to FIGS. 10-11, each of the conical or square transducer elements may be used to create fish arches for sonar imagery for the linear transducer element with which the conical or square transducer element is paired. As shown in FIG. 5, the first sonar device 211 is attached circumferentially around the outer shaft 209 and is rotatable along a path R4 around the outer shaft 209. The first sonar device 211 may also be adjustable along the outer shaft 209 along a vertically aligned axis V3. It should be appreciated that, although the first sonar device 211 is shown as being rotatable around the outer shaft 209 in FIG. 5, that in other embodiments, the first sonar device 211 may be rotatable around the inner shaft 213 and/or may be adjustable along the inner shaft 213 and/or the outer shaft 209 along the vertically aligned axis V3. In either case, movement of the first sonar device 211 may be via a second motor that is coupled to the first sonar device 211. Further, in some other embodiments, the first sonar device 211 (which may or may not be a 360-degree sonar imaging device) may be stationary and therefore non-rotatable around the inner shaft 213 and/or the outer shaft 209. Other configurations are also contemplated within the scope of this disclosure.

In embodiments in which the first sonar device 211 is a 360-degree sonar imaging device and is rotatable via the second motor, the second motor may be configured to cause each linear transducer element of the 360-degree sonar imaging device to adjust a facing direction along an arc of angles about the outer shaft 209 in a back-and-forth manner. For example, the second motor may cause the facing direction of each linear transducer element of the 360-degree sonar imaging device to adjust between a 0-degree reference point and a point that is 120 degrees from the 0-degree reference point. The 360-degree sonar imaging device may thus be configured to produce a 360-degree sonar image of an underwater environment beneath the sonar device assembly 299 built up of the three portions of 120-degrees of sonar imagery (although more or less portions are contemplated).

In the embodiment shown in FIG. 5, the second sonar device 214 is a live sonar imaging device that includes three sonar transducer arrays. As shown, the second sonar device 214 may be pivotable with respect to the inner shaft 213 within a vertical plane along path R5 and may also be movable via up-and-down movement of the inner shaft 213 along vertical axis V4. In some further embodiments, the second sonar device 214 may also be pivotable with respect to the inner shaft 213 within a horizontal plane along path R6. Such pivoting may be accomplished using a shaft 218 that is attached to the second sonar device 214 and pivotable by a user or a motor on an opposite end of the shaft 218. For example, the user may move the opposite end of the shaft 218, which is located outside of the body of water, in an up-and-down and/or circular motion to cause the second sonar device 214 to move along one or both of paths R5 and/or R6. Further, the opposite end of the shaft 218 that is outside of the body of water may be connected to a third motor, which may be controlled by a processor, that does the same. The shaft 218 may additionally or alternatively act as a connection mechanism for when the sonar device assembly 299 is stowed (e.g., see FIG. 2).

The sonar device assembly 209 may be configured such that a vertical distance D2 between the first sonar device 211 and the second sonar device 214 is such that the second sonar device 214 does not hinder a first imaging volume of the first sonar device 211 and such that the first sonar device 211 does not hinder a second imaging volume of the second sonar device 214. That is, the first sonar device 211 and the second sonar device 214 may be positioned and/or may be adjustable such that images produced by each are not hindered by each other. For example, the vertical distance D2 may be short enough such that the second sonar device 214 does not intersect with the beams emitted by the transducer elements of the first sonar device 211, which may be emitted in an outward and downward direction (e.g., see FIG. 8). This may be accomplished by movement of one or both of the first sonar device 211 along the first vertical axis V3 or the second sonar device 214 along the second vertical axis V4. As another example, the second sonar device 214 may, in some embodiments, have a length that is longer than its width, while the first sonar device 211 may have a triangular-like shape (as shown). In such a case, it may be desirable to move the second sonar device 214 along one or both of the radial path R5 or the radial path R6 (in addition to or as an alternative to moving one or both of the first sonar device 211 along the first vertical axis V3 or the second sonar device 214 along the second vertical axis V4) to ensure that the second sonar device 214 does not intersect with the beams emitted by the transducer elements of the first sonar device 211.

It should be appreciated that, although the first sonar device 211 in FIG. 5 is a 360-degree sonar imaging device and the second sonar device 214 in FIG. 5 is a live sonar imaging device, in other embodiments, the first sonar device 211 and the second sonar device 214 may be any other type of sonar device. Further, the sonar device assembly 299 may include more or less sonar devices than shown in FIG. 5, and the one or more sonar devices may be configured differently, e.g., depending on the type of sonar device-such as described above with respect to FIG. 4.

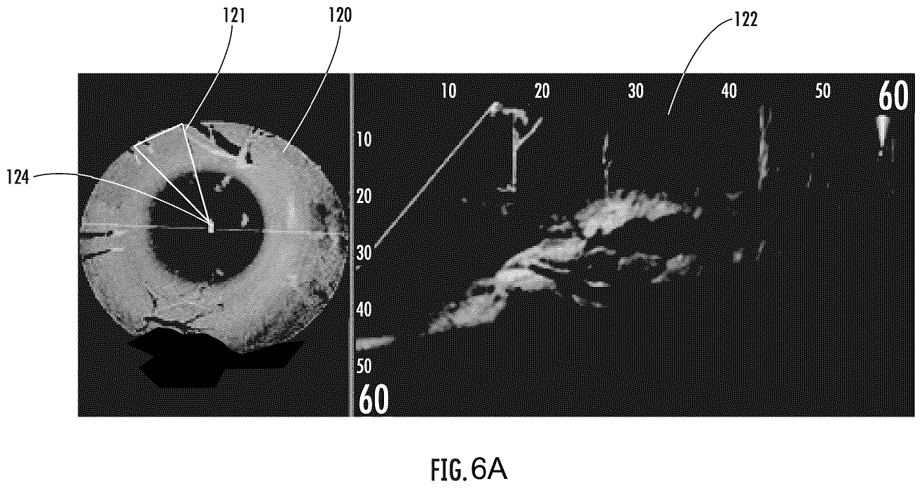

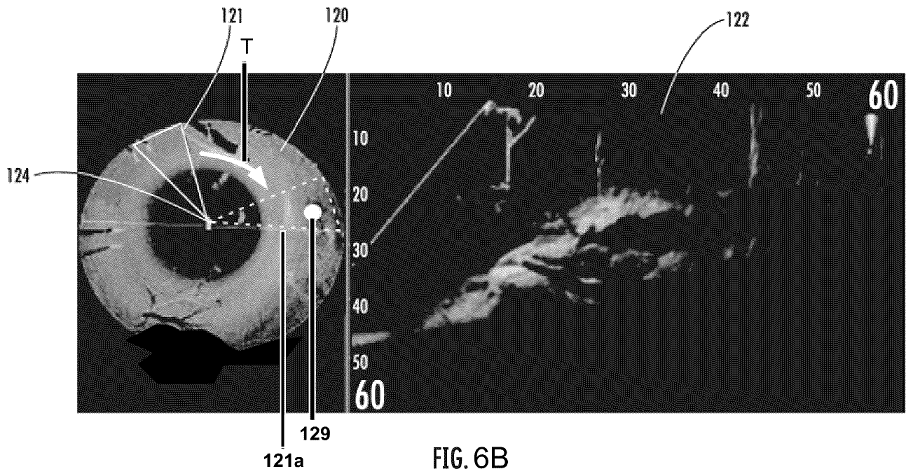

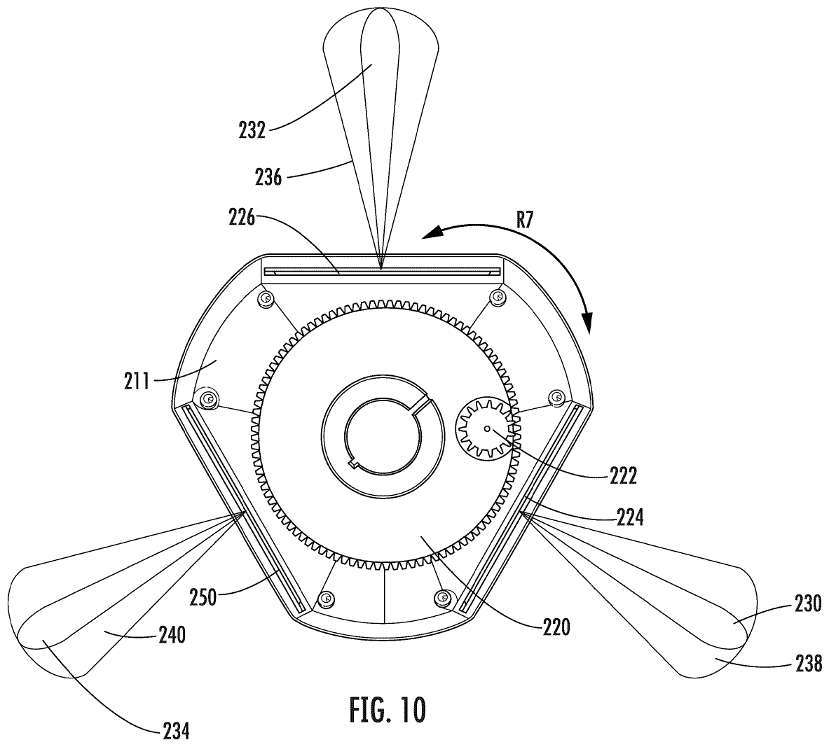

FIG. 6A shows a display with a 360-degree sonar image 120 on the left and a live sonar image 122 on the right. For example, the 360-degree sonar image 120 may be produced by a sonar device such as the first sonar device 111 or the first sonar device 211, and the live sonar image 122 may be produced by a sonar device such as the second sonar device 114 or the second sonar device 214. As shown, the 360-degree sonar image 120 includes a watercraft 124 in the center of a 360-degree view of the underwater environment. As will be shown and described with respect to FIG. 9, the 360-degree view of the underwater environment may be developed by compiling historical image slices of the underwater environment. The live sonar image 122 is a live forward view of a portion of the underwater environment (e.g., as indicated by live beam shape indicator 121, which indicates the portion of the underwater environment from the 360-degree sonar image 120 that is being shown in the live sonar image 122). The live forward view may be continually updated using data obtained from a second sonar device (such as the second sonar device 114 or the second sonar device 214). Each of the views may be useful to a user for different reasons, often at the same time. For example, the 360-degree sonar image 120 may be helpful for identifying groups of fish or underwater objects, whereas the live sonar image 122 may be helpful for determining details about a group of fish or an underwater object. Further, the live sonar image 122 may be steerable in real time to, e.g., explore in detail a portion of the underwater environment that is covered more broadly in the 360-degree sonar image 120. That is, the live beam shape indicator 121 shown overtop the 360-degree sonar image 120 may be steerable, and as the live beam shape indicator 121 is steered and updated, the live sonar image 122 may be updated accordingly. In some embodiments, a user may provide an indication of a position within the 360-degree sonar image 120 and the corresponding other sonar device that is steerable may be steered so as to provide sonar coverage of the position. Accordingly, the live sonar image 122 may be updated, thereby showing what is at the position. For example, FIG. 6B illustrates that a user has provided input (e.g., a touch gesture) to a position 129 within the 360-degree sonar image 120. Accordingly, the system determined a steering adjustment for the live sonar imaging device (e.g., based on a determined direction that will cause the live sonar image to show the indicated position), and caused the live sonar imaging device to steer (e.g., along arrow T, such as by causing the motor to operate to steer the sonar imaging device) to provide sonar coverage of the position 129. Accordingly, the position of the live beam shape indicator 121a has updated to indicate the sonar coverage of the position 129. Other uses of the 360-degree sonar image 120 and the live sonar image 122 are also contemplated within the scope of this disclosure.

It should be appreciated that a first sonar device (such as the first sonar device 111 or the first sonar device 211) and a second sonar device (such as the second sonar device 114 or the second sonar device 214) may be configured to work together. For example, a facing direction of the second sonar device, which may produce the live sonar image 122 in FIG. 6, may be determined based on an object that is detected in the 360-degree sonar image 120. Further, the second sonar device may be used to track a certain object that was originally identified in the 360-degree sonar image 120, via the live sonar image 122, and that object may even be annotated within the 360-degree sonar image 120 (and/or the live sonar image 122) in some embodiments. As another example, the 360-degree sonar image 120 may be replaced with a partial sonar image such as a 180-degree sonar image or a 75-degree sonar image such that what is shown in the image on the left in FIG. 6 corresponds to the live sonar image 122 on the right. Other configurations are also contemplated within the scope of this disclosure.

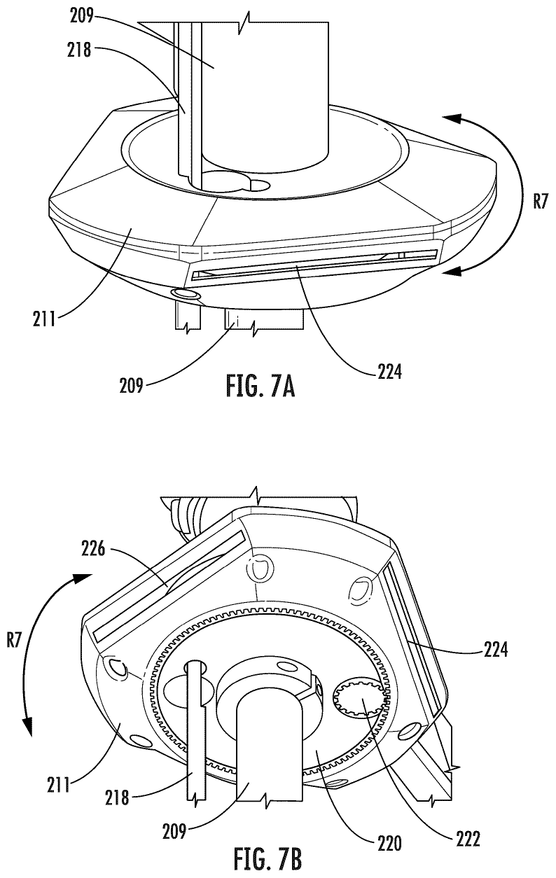

FIGS. 7A-7B show zoomed-in views of the first sonar device 211 of FIG. 5. As shown, the first sonar device 211 includes a first linear transducer element 224 and a second linear transducer element 226, along with a third linear transducer element 250 (which is not shown in FIGS. 7A-7B but is shown in FIG. 10). The second motor, which is configured to cause the first sonar device 211 to rotate around the outer shaft 209, includes an outer gear 220 and an inner gear 222. The inner gear 222 and the outer gear 220 are configured to interact with each other to cause the first linear transducer element 224, the second linear transducer element 226, and the third linear transducer element 250, which are integrated in the first sonar device 211, to rotate around the outer shaft 209 along radial path R7. It should be appreciated that, in some embodiments, the rotation of the outer gear 220 and the inner gear 222 may cause rotation of the first sonar device 211 without rotating or otherwise affecting the inner shaft 213. The shaft 218 (which may be optional in some embodiments) passes through a hole extending through the outer gear 220 and the first sonar device 211.

Referring now to FIG. 8, each of the linear transducer elements may emit acoustic beams into the underwater environment and then receive reflections from those acoustic beams to create sonar images. The first linear transducer element 224 emits a first beam 230, the second linear transducer element 226 emits a second beam 232, and the third linear transducer element 250 emits a third beam 234. Each of the first beam 230, second beam 232, and third beam 234 are narrow in the direction in which the length of the respective linear transducer element spans and elongated in the direction in which the height of the respective linear transducer element spans. For example, the first linear transducer element 224 has a length L and a height H. The first beam 230 is narrow along an axis defined by the length L and elongated (e.g., tall) along an axis defined by the height H. The same is true for each of the second beam 232 with respect to the second linear transducer element 226 and the third beam 234 with respect to the third linear transducer element 250 (shown in FIG. 10). As the second motor (e.g., inner gear 222 and outer gear 220) causes rotation of the first sonar device 211 about the outer shaft 209 (or, in other embodiments, about the inner shaft 213), the first beam 230, the second beam 232, and the third beam 234 capture sonar data from different portions of the underwater environment. The historical build up of such sonar data can be compiled to form a 360-degree sonar image of the underwater environment.

FIG. 9 shows a buildup pattern that illustrates how the 360-degree sonar image 120 of FIG. 6 may be created using the linear sonar transducer elements 224, 226, and 250 and corresponding beams 230, 232, and 234 of FIG. 8. That is, as mentioned above, each of the linear sonar transducer elements 224, 226, and 250 of the first sonar device 211 (e.g., a 360-degree sonar imaging device) may be configured to adjust a facing direction along an arc of angles about the outer shaft 209 in a back-and-forth manner. For example, the second motor may cause the facing direction of each linear transducer element of the 360-degree sonar imaging device to adjust between a 0-degree reference point and a point that is 120 degrees from the 0-degree reference point. The first sonar device 211 may thus be configured to produce a 360-degree sonar image of an underwater environment beneath the sonar device assembly 299. To illustrate, FIG. 9 shows an X axis, a Y axis, and a Z axis. The first linear transducer element 224 provides beam coverage of the portion of the image spanning from the X axis to the Y axis, the second linear transducer element 226 provides beam coverage of the portion of the image spanning from the Z axis to the X axis, and the third linear transducer element 250 provides beam coverage of the portion of the image spanning from the Y axis to the Z axis. That is, the beams 230, 232, and 234 move along paths P1, P3, and P2, respectively, as the second motor causes rotation of the first sonar device 211 about the outer shaft 209, and slices of sonar data are obtained and compiled to form the sonar image 120.

For example, as the first sonar device 211 rotates in a clockwise direction (with respect to FIG. 9), the first beam 230 moves from a first position in which it obtains sonar data to form a first slice 252 of the sonar image 120, to a second position in which it obtains sonar data to form a second slice 252a of the sonar image 120, to a third position in which it obtains sonar data to form a second slice 252b of the sonar image 120, and continues until the entire path PI has been traveled and the entire portion of the sonar image 120 from the X axis to the Y axis is formed. The second motor then changes direction and causes the first sonar device 211 to rotate in the opposite direction (e.g., in a counterclockwise direction with respect to FIG. 9). The slices of the sonar image 120 are updated one by one as the rotation occurs so that the entire portion of the sonar image 120 from the X axis to the Y axis is updated. This process continues as long as the processor(s) that is connected to the second motor and that is responsible for compiling the sonar image 120 causes it to continue.

Similarly, as the first sonar device 211 rotates in a clockwise direction (with respect to FIG. 9), the second beam 232 moves from a first position in which it obtains sonar data to form a first slice 256 of the sonar image 120, to a second position in which it obtains sonar data to form a second slice 256a of the sonar image 120, to a third position in which it obtains sonar data to form a second slice 256b of the sonar image 120, and continues until the entire path P3 has been traveled and the entire portion of the sonar image 120 from the Z axis to the X axis is formed. The second motor then changes direction and causes the first sonar device 211 to rotate in the opposite direction (e.g., in a counterclockwise direction with respect to FIG. 9). The slices of the sonar image 120 are updated one by one as the rotation occurs so that the entire portion of the sonar image 120 from the Z axis to the X axis is updated. This process continues as long as the processor(s) that is connected to the second motor and that is responsible for compiling the sonar image 120 causes it to continue.

As the first sonar device 211 rotates in a clockwise direction (with respect to FIG. 9), the third beam 234 moves from a first position in which it obtains sonar data to form a first slice 254 of the sonar image 120, to a second position in which it obtains sonar data to form a second slice 254a of the sonar image 120, to a third position in which it obtains sonar data to form a second slice 254b of the sonar image 120, and continues until the entire path P2 has been traveled and the entire portion of the sonar image 120 from the Y axis to the Z axis is formed. The second motor then changes direction and causes the first sonar device 211 to rotate in the opposite direction (e.g., in a counterclockwise direction with respect to FIG. 9). The slices of the sonar image 120 are updated one by one as the rotation occurs so that the entire portion of the sonar image 120 from the Y axis to the Z axis is updated. This process continues as long as the processor(s) that is connected to the second motor and that is responsible for compiling the sonar image 120 causes it to continue.

FIG. 10 illustrates the first sonar device 211 of FIGS. 5 and 7A-8, the first sonar device 211 having three conical or square transducer elements in addition to the first linear transducer element 224, the second linear transducer element 226, and the third linear transducer element 250. Although not shown, the embodiment shown in FIG. 10 includes three conical transducer elements, and each of the conical transducer elements are positioned at midpoints along the lengths of the first linear transducer element 224, the second linear transducer element 226, and the third linear transducer element 250 and emit conical beams. That is, the first conical transducer element emits a first conical beam 238, the second conical transducer element emits a second conical beam 236, and the third conical transducer element emits a third conical beam 240. Notably, the first conical beam 238, the second conical beam 236, and the third conical beam 240 are not narrow or elongated in any direction (such as are the first beam 230, the second beam 232, and the third beam 234). Instead, the first conical beam 238, the second conical beam 236, and the third conical beam 240 are evenly dispersed cones (or pyramids, in the case of square transducer elements). As will be shown and described with respect to FIG. 11, the first conical beam 238, the second conical beam 236, and the third conical beam 240 are used to develop fish arches (among other things).

FIG. 11 is a 360-degree sonar image that may be created using linear sonar transducer elements and conical or square transducer elements, such as those shown and described with respect to FIGS. 8 and 10. An icon 261 of the watercraft is shown in the center of the 360-degree sonar image. The base portion 260 of the 360-degree sonar image may be developed using the historical build up method shown and described with respect to FIG. 9, which uses sonar data from the first linear transducer element 224, the second linear transducer element 226, and the third linear transducer element 250, which emit the first beam 230, the second beam 232, and the third beam 234, respectively. A first fish arch 262, a second fish arch 264, a third fish arch 266, a fourth fish arch 268, and a fifth fish arch 270 are developed using sonar data from the three conical transducer elements, which emit the first conical beam 238, the second conical beam 236, and the third conical beam 240, respectively. Such fish arches, which may be desirable fish finding features, may be developed by obtaining historical sonar data from the conical sonar transducer elements, forming one-dimensional sonar images with the built-up historical sonar data, and then extracting fish arches from those sonar images. The extracted fish arches are then overlaid onto the base portion 260 of the 360-degree sonar image in the corresponding location. This may be useful in many situations, such as when a user is looking for desirable fishing locations near the watercraft. This may be especially useful for certain users who are accustomed to looking at one-dimensional sonar images such as those from which the fish arches are extracted.

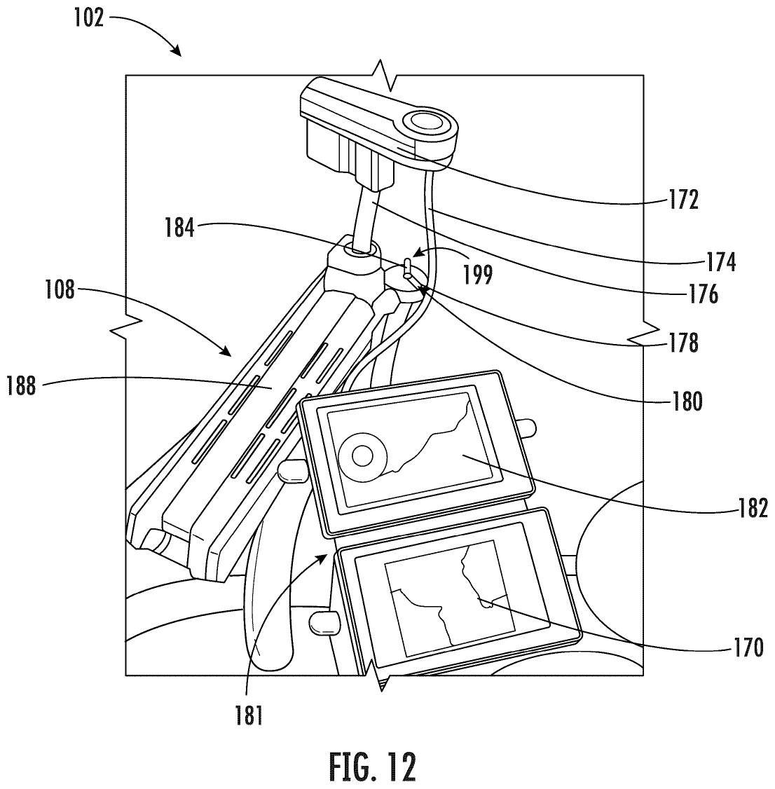

FIG. 12 illustrates a navigation configuration for an out-of-water portion of the assembly 102. As shown, the assembly 102 includes a trolling motor top portion 172 that may, in some embodiments, provide an indication of which direction the trolling motor propellor is facing. The trolling motor top portion 172 is connected to an above-water portion 188 of the trolling motor assembly 108 via a shaft 176 and is connected to a marine electronic device 181 via a cord 176. The marine electronic device 181 may include a first display 182 and/or a second display 170. In the embodiment shown in FIG. 12, the first display 182 displays data from the first sonar device 111, and the second display 170 displays data from the second sonar device 114. This may allow the user to easily and quickly gain knowledge of the underwater environment using data obtained using the sonar device assembly 199 of the assembly 102. It should be appreciated, however, that the first display 182 and/or the second display 170 may display any other type of data.

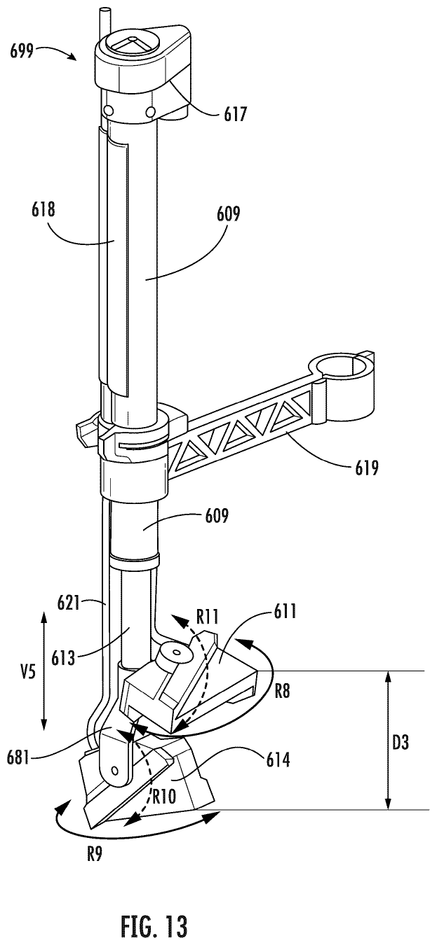

The sonar device assembly 199 includes an indicator 180 with a first directional indicator 178 and a second directional indicator 184. The first directional indicator 178 and the second directional indicator 184 may be configured to (e.g., automatically) indicate the facing directions of the first sonar device 111 and the second sonar device 114, respectively (when the first sonar device 111 and/or the second sonar device 114 have facing directions (e.g., see FIG. 13, in which both sonar devices have facing directions)). The first directional indicator 178 and the second directional indicator 184 may, for example, appear on a small screen that updated according to a processor that may, for example, by within or in communication with the marine electronic device 181. The first directional indicator 178 and the second directional indicator 184 may serve to inform the user of how the below-water components are configured at any given moment. It should be appreciated that the first directional indicator 178 and the second directional indicator 184 may be optional in some embodiments, and that in some embodiments, additionally or alternatively, such indications may be made on one or both of the first screen 182 or the second screen 170 of the marine electronic device 181.

In some embodiments, the marine electronic device 181 may be used to control one or both of the trolling motor assembly 108 and/or the sonar device assembly 199. Additionally or alternatively, one or both of the trolling motor assembly 108 and/or the sonar device assembly 199 may be controlled by a remote, a foot pedal, a mobile device, or any other mechanism or method.

Notably, the assembly 102 is configured such that the sonar device assembly 199 can be used independently from and simultaneously with the trolling motor assembly 108. That is, although the indicator 180 may be pointing in one direction, the propellor associated with the trolling motor assembly 108 may not be pointing in that same direction. This is advantageous over other systems, which require a trolling motor assembly to be disabled during use of a sonar device assembly or require the trolling motor assembly and the sonar device assembly to point in corresponding directions when being operated.

FIG. 13 illustrates an isolated view of another example sonar device assembly 699. Similar to the sonar device assembly 199 and 299 described above, the sonar device assembly 699 may include a base component 617, an outer shaft 609, an inner shaft 613, a first sonar device 611, a second sonar device 614, and a support arm 619. The sonar device assembly 699 may be configured such that a first motor coupled to the inner shaft 613 causes rotation of the inner shaft 613 and therefore rotation of the second sonar device 614. Additionally, the first sonar device 611 may be, in some embodiments, rotatable around the inner shaft 613 (or the outer shaft 609) via a second motor that is coupled to the first sonar device 611.

In the embodiment shown, the first sonar device 611 is a live sonar imaging device. In some embodiments, the live sonar imaging device (e.g., the first sonar device 611) includes three linear sonar transducer arrays. As shown, the first sonar device 611 may be pivotable with respect to the inner shaft 613 within a vertical plane along the path R8 and may also be movable via up-and-down movement of the inner shaft 613 along vertical axis V5. In some further embodiments, the first sonar device 611 may also be pivotable with respect to the inner shaft 613 within a horizontal plane along path R11 via, e.g., an additional motor and/or shaft.

It should be appreciated that, although the first sonar device 611 is shown as being rotatable around the inner shaft 613 in FIG. 13, that in other embodiments, the first sonar device 611 may be rotatable around the outer shaft 609 and/or may be adjustable along the inner shaft 613 and/or the outer shaft 609 along the vertically aligned axis V5. In either case, movement of the first sonar device 611 may be via a second motor that is coupled to the first sonar device 611. Further, in some other embodiments, the first sonar device 611 (which may or may not be a live sonar imaging device) may be stationary and therefore non-rotatable around the inner shaft 613 and/or the outer shaft 609. Other configurations are also contemplated within the scope of this disclosure.

In the embodiment shown in FIG. 13, the second sonar device 614 is also a live sonar imaging device that includes three sonar transducer arrays. As shown, the second sonar device 614 may be pivotable with respect to the inner shaft 613 within a vertical plane along path R9 and may also be movable via up-and-down movement of the inner shaft 613 along vertical axis V5. In some further embodiments, the second sonar device 614 may also be pivotable with respect to the inner shaft 613 within a horizontal plane along path R10. Such pivoting may be accomplished using a shaft 621 that is attached to the second sonar device 614 and pivotable by a user on an opposite end of the shaft 621. For example, the user may move the opposite end of the shaft 621, which is located outside of the body of water, in an up-and-down and/or circular motion to cause the second sonar device 614 to move along one or both of paths R9 and/or R10. Further, the opposite end of the shaft 621 that is outside of the body of water may be connected to a third motor, which may be controlled by a processor, that does the same. The shaft 621 may additionally or alternatively act as a connection mechanism for when the sonar device assembly 699 is stowed (e.g., see FIG. 2).

The sonar device assembly 209 may be configured such that a vertical distance D3 between the first sonar device 611 and the second sonar device 614 is such that the second sonar device 614 does not hinder a first imaging volume of the first sonar device 611 and such that the first sonar device 611 does not hinder a second imaging volume of the second sonar device 614. That is, the first sonar device 611 and the second sonar device 614 may be positioned and/or may be adjustable (e.g., via adjustment of the bracket 681) such that images produced by each are not hindered by each other. For example, the vertical distance D3 may be short enough such that the second sonar device 614 does not intersect with the beams emitted by the transducer arrays of the first sonar device 611, which may be emitted in an outward and slightly downward direction. This may be accomplished by movement of one or both of the first sonar device 611 and the second sonar device 614 along the vertical axis V5. As another example, the first sonar device 611 and the second sonar device 614 may each, in some embodiments, have a length that is longer than its width. In such a case, it may be desirable to move the second sonar device 214 along one or both of the radial path R9 or the radial path R10 (in addition to or as an alternative to moving one or both of the first sonar device 611 or the second sonar device 614 along the vertical axis V5) to ensure that the second sonar device 614 does not intersect with the beams emitted by the transducer arrays of the first sonar device 611.

It should be appreciated that, although the first sonar device 611 and the second sonar device 614 are connected by a bracket 681 in FIG. 13, and the first sonar device 611 and the second sonar device 614 are both rotatable via the inner shaft 613, in other embodiments, one or both of the first sonar device 611 and the second sonar device 614 may be attached to the sonar device assembly 699 differently (e.g., independently without bracket 681). Further, one or both of the first sonar device 611 and the second sonar device 614 may be rotatable around the outer shaft 609 in some other embodiments. Other configurations are also contemplated within the scope of this disclosure.

It should also be appreciated that, although the first sonar device 611 and the second sonar device 614 in FIG. 13 are both live sonar imaging devices, in other embodiments, the first sonar device 611 and the second sonar device 614 may be any other type of sonar device. Further, the sonar device assembly 699 may include more or less sonar devices than shown in FIG. 13, and the one or more sonar devices may be configured differently, e.g., depending on the type of sonar device.

### Example System Architecture

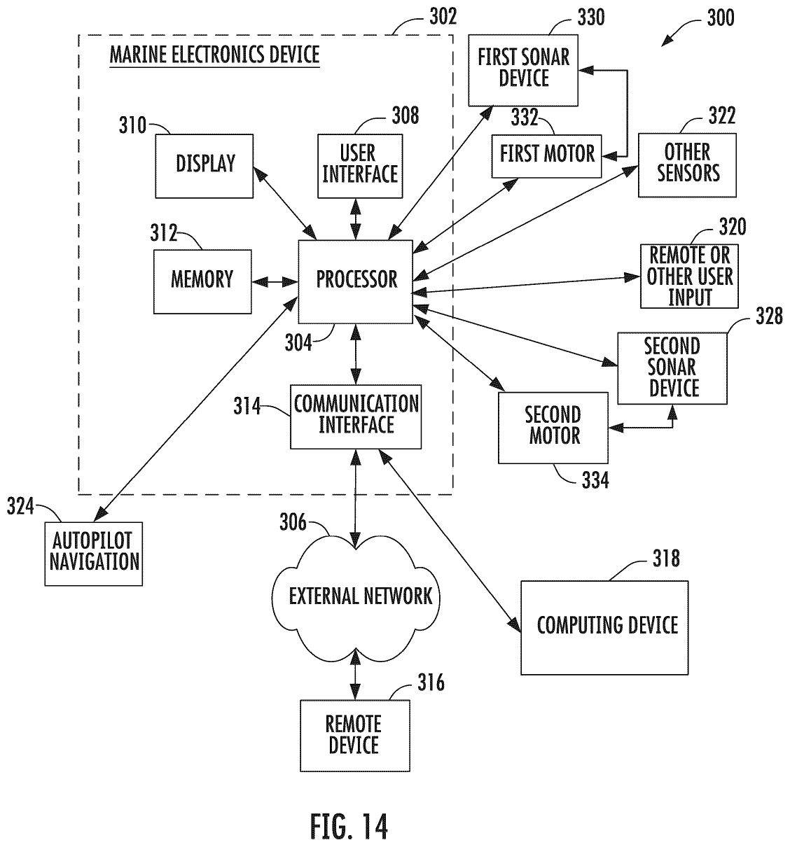

FIG. 14 shows a block diagram of an example system 300 capable for use with several embodiments of the present disclosure. As shown, the system 300 may include a number of different modules or components, each of which may comprise any device or means embodied in either hardware, software, or a combination of hardware and software configured to perform one or more corresponding functions. For example, the system 300 may include a marine electronics device 302 (e.g., controller) and various sensors/systems usable with a sonar device assembly of an assembly, as described herein.

The marine electronics device 302, controller, remote control, MFD, and/or user interface display may include a processor 304, a memory 312, a communication interface 314, a user interface 308, a display 310, and one or more sensors (e.g., other sensors 322, which may be in the marine electronics device 302 or otherwise operatively connected (e.g., wired or wirelessly)). In some embodiments, the processor 304 may include an autopilot navigation assembly 324.

The processor 304 may be in communication with one or more devices such as first sonar device 330, second sonar device 328, first motor 332, second motor 334, remote or other user input 320, and/or other sensors 322 to control an assembly that includes a sonar device assembly (e.g., that may include one or more of the first sonar device 330, the second sonar device 328, the first motor 332, the second motor 334, and/or one or more of the other sensors 322) and a trolling motor assembly. For example, the processor 304 may receive user input or other instructions from the remote or other user input 320, from autopilot navigation 324, and/or from any other component such as remote device 316, and the processor 304 may use that received data to make a determination. In some embodiments, the received data may indicate a desired direction of a trolling motor assembly of an assembly and/or a desired instruction to operate a sonar device assembly of the assembly, the sonar device assembly including, e.g., the first sonar device 330, the second sonar device 328, the first motor 332, the second motor 334, and/or one or more of the other sensors 322, and the processor 304 may be used to determine instructions and/or input values to send to components such as the first sonar device 330, the second sonar device 328, the first motor 332, the second motor 334, and/or one or more of the other sensors 322 to obtain sonar data from the sonar device assembly that it can use to compile and display desired sonar imagery, as described herein. The remote or other user input 320 may include a remote and/or a touchscreen in some embodiments, and in other embodiments, the received data may be obtained through any other interface or mechanism. The processor 304 may use external data from other components such as the autopilot navigation 324, the memory 312, the remote device 316 (via the communication interface 314 and the external network 306), the computing device 318, and/or the other sensors 322 to make such determinations, as described herein. For example, data from the first sonar device 330 may be used by the processor 304 to obtain 360-degree sonar data that can be compiled into a 360-degree sonar image, and processor 304 and the memory 312 may be used to instruct the second motor 334 according to what the processor 304 determines is shown in the 360-degree sonar image developed using the first sonar device 330. In such case, the processor 304 might determine instructions that aim to use the second sonar device 328 to explore in more detail an area captured using data from the first sonar device 330.

A sonar device assembly of an assembly may include the first sonar device 330 and the second sonar device 328, which each include one or more sonar transducer assembly(s), which may be any type of sonar transducer (e.g., a linear transducer element, a conical or square transducer element, a transducer array (e.g., for forming live and/or 360-degree sonar), among many others known to one of ordinary skill in the art). The sonar transducer assembly(s) may be housed in each of the first sonar device 330 and the second sonar device 328 and configured to gather sonar data from the underwater environment relative to the marine vessel. Accordingly, the processor 304 (such as through execution of computer program code) may be configured to adjust an orientation of the sonar transducer assembly(s) and receive an indication of operation of the sonar transducer assembly(s). The processor 304 may generate additional display data indicative of the operation of the sonar transducer assembly(s) and cause the display data to be displayed on the display 310. For example, a sonar icon (not shown) may be energized to indicate that the sonar transducer assembly(s) is/are operating.

The processor 304 may be positioned within the marine electronics device 302 in some embodiments, as shown in FIG. 14, but in other embodiments, the processor 304 may be positioned anywhere else. For example, the processor 304 may be positioned within the remote or other user input 320, at a remote location, or within any other component shown in FIG. 14.

In some embodiments, the system 300 may be configured to receive, process, and display various types of marine data. In some embodiments, the system 300 may include one or more processors 304 and the memory 312. Additionally, the system 300 may include one or more components that are configured to gather marine data or perform marine features. In such a regard, the processor 304 may be configured to process the marine data and generate one or more images corresponding to the marine data for display on the screen that is integrated in the marine electronics device 302. Further, the system 300 may be configured to communicate with various internal or external components (e.g., through the communication interface 314), such as to provide instructions related to the marine data.

The processor 304 may be any means configured to execute various programmed operations or instructions stored in a memory, such as a device and/or circuitry operating in accordance with software or otherwise embodied in hardware or a combination thereof (e.g., a processor operating under software control, a processor embodied as an application specific integrated circuit (ASIC) or field programmable gate array (FPGA) specifically configured to perform the operations described herein, or a combination thereof) thereby configuring the device or circuitry to perform the corresponding functions of the processor 304 as described herein. In this regard, the processor 304 may be configured to analyze electrical signals communicated thereto to provide, e.g., display data to the display 310.

The memory 312 may be configured to store instructions, computer program code, marine data (e.g., sonar data, chart data, location/position data), and/or other data associated with the system 300 in a non-transitory computer readable medium for use by the processor, for example.

The system 300 may also include one or more communications modules configured to communicate via any of many known manners, such as via a network, for example. The processing circuitry and communication interface 314 may form a processing circuitry/communication interface. The communication interface 314 may be configured to enable connections to external systems (e.g., an external network 306 or one or more remote controls, such as a handheld remote control, marine electronics device, foot pedal, or other remote computing device). In this regard, the communication interface (e.g., 314) may include one or more of a plurality of different communication backbones or frameworks, such as Ethernet, USB, CAN, NMEA 2000, GPS, Sonar, cellular, Wi-Fi, and/or other suitable networks, for example. In this manner, the processor 304 may retrieve stored data from a remote, external server via the external network 306 in addition to or as an alternative to the onboard memory 312. The network may also support other data sources, including GPS, autopilot, engine data, compass, radar, etc. Numerous other peripheral, remote devices such as one or more wired or wireless multi-function displays may be connected to the system 300.

It should be appreciated that devices and/or systems such as the first sonar device 330, the second sonar device 328, the first motor 332, the second motor 334, the remote or other user input 320, the other sensors 322, and even other components, may, in some other embodiments, be in communication with a processor such as the processor 304 through a network such as the external network 306. That is, in some other embodiments, the first sonar device 330, the second sonar device 328, the first motor 332, the second motor 334, the remote or other user input 320, the other sensors 322, and even other components, may be in direct communication with a network that is connected to the processor 304 rather than being in direct communication with the processor 304 itself. In some other embodiments, the first sonar device 330, the second sonar device 328, the first motor 332, the second motor 334, the remote or other user input 320, the other sensors 322, and even other components, may be in direct communication with the processor 304 and may also be in direct communication with a network. Other configurations are also contemplated.

The processor 304 may configure the marine electronic device 302 and/or circuitry to perform the corresponding functions of the processor 304 as described herein. In this regard, the processor 304 may be configured to analyze electrical signals communicated thereto to provide, for example, various features/functions described herein.

In some embodiments, the system 300 may be configured to determine the location of the marine vessel, such as through a location sensor. The system 300 may comprise, or be associated with, a navigation system that includes the location sensor. For example, the location sensor may comprise a GPS, bottom contour, inertial navigation system, such as a micro-electro-mechanical system (MEMS) sensor, a ring laser gyroscope, or the like, or other location detection system. In such a regard, the processor 304 may be configured to act as a navigation system. For example, the processor 304 may generate at least one waypoint and, in some cases, generate an image of a chart along with the waypoint for display by the screen. Additionally or alternatively, the processor may generate one or more routes associated with the watercraft. The location of the vessel, waypoints, and/or routes may be displayed on a navigation chart on a display remote from the system 300. Further, additional navigation features (e.g., providing directions, weather information, etc.) are also contemplated.

In addition to position, navigation, and sonar data, example embodiments of the present disclosure contemplate receipt, processing, and generation of images that include other marine data. For example, the display 310 and/or user interface 308 may be configured to display images associated with vessel or motor status (e.g., gauges) or other marine data.

In any of the embodiments, the display 310 may be configured to display an indication of the current direction of the marine vessel.

The display 310 may be configured to display images and may include or otherwise be in communication with a user interface 308 configured to receive input from a user. The display 310 may be, for example, a conventional liquid crystal display (LCD), LED/OLED display, touchscreen display, mobile media device, and/or any other suitable display known in the art, upon which images may be displayed. In some embodiments, the display 310 may be the MFD and/or the user's mobile media device. The display may be integrated into the marine electronic device 302. In some example embodiments, additional displays may also be included, such as a touch screen display, mobile media device, or any other suitable display known in the art upon which images may be displayed.

In some embodiments, the display 310 may present one or more sets of marine data and/or images generated therefrom. Such marine data may include chart data, radar data, weather data, location data, position data, orientation data, sonar data, and/or any other type of information relevant to the marine vessel. In some embodiments, the display 310 may be configured to present marine data simultaneously as one or more layers and/or in split-screen mode. In some embodiments, the user may select various combinations of the marine data for display. In other embodiments, various sets of marine data may be superimposed or overlaid onto one another. For example, a route may be applied to (or overlaid onto) a chart (e.g., a map or navigation chart). Additionally, or alternatively, depth information, weather information, radar information, sonar information, and/or any other display inputs may be applied to and/or overlaid onto one another.

In some embodiments, the display 310 and/or user interface 308 may be a screen that is configured to merely present images and not receive user input. In other embodiments, the display and/or user interface may be a user interface such that it is configured to receive user input in some form. For example, the screen may be a touchscreen that enables touch input from a user. Additionally, or alternatively, the user interface may include one or more buttons (not shown) that enable user input.

The user interface 308 may include, for example, a keyboard, keypad, function keys, mouse, scrolling device, input/output ports, touch screen, or any other mechanism by which a user may interface with the system.

In some embodiments, the system 300 may comprise an autopilot navigation 324 that may direct the marine vessel to a waypoint (e.g., a latitude and longitude coordinate). Additionally, or alternatively, the autopilot may be configured to direct the marine vessel along a route, such as in conjunction with the navigation system. The processor 304 may generate display data based on the autopilot operating mode and cause an indication of the autopilot operating mode to be displayed on the digital display in the first portion, such as an autopilot icon. Further, the autopilot navigation 324 may be configured to provide information to the processor 304 that aids in instructions transmitted to the first sonar device 330, the second sonar device 328, the first motor 332, the second motor 334, the remote or other user input 320, and/or the other sensors 322 (e.g., to obtain desirable sonar data, etc.).

In some embodiments, the first sonar device 330, the second sonar device 328, the first motor 332, the second motor 334, the remote or other user input 320, and/or the other sensors 322 may be used to determine depth and bottom topography, detect fish, locate wreckage, etc. Sonar beams, from one of the sonar transducer assemblies, can be transmitted into the underwater environment. The sonar signals reflect off objects in the underwater environment (e.g., fish, structure, sea floor bottom, etc.) and return to the sonar transducer assembly, which converts the sonar returns into sonar data that can be used to produce an image of the underwater environment.

In an example embodiment, the other sensors 322 may include a speed sensor, such as an electromagnetic speed sensor, paddle wheel speed sensor, or the like. The speed sensor may be configured to measure the speed of the marine vessel through the water. The processor 304 may receive speed data from the speed sensor and generate additional display data indicative of the speed of the marine vessel through the water. The speed data may be displayed, such as in text format on the first portion of the digital display. The speed data may be displayed in any relevant unit, such as miles per hour, kilometers per hour, feet per minute, or the like. In some instances, a unit identifier, such as a plurality of LEDs, may be provided in association with the display (may be shown in normal text or with a seven-digit display). The processor 304 may cause an LED associated with the appropriate unit for the speed data to be illuminated.

In some embodiments, the system 300 further includes one or more power sources (e.g., batteries) that are configured to provide power to the various components. In some embodiments, a power source may be rechargeable. In some example embodiments, the system 300 includes one or more battery sensor(s). The battery sensor(s) may include one or more current sensors or voltage sensors configured to measure the current charges of battery power supplies of the system 300. The battery sensor(s) may be configured to measure individual battery cells or measure a battery bank. The processor 304 may receive battery data from the battery sensor(s) and determine the remaining charge on the battery or batteries. In an example embodiment, the voltages or currents measured by the battery sensor(s) may be compared to a reference value or data table, stored in memory 312, to determine the remaining charge(s) on the battery or batteries.

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in general context of computer-executable instructions, such as program modules, being executed by a computer. Generally, program modules may include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some instances, program modules may be implemented on separate computing systems and/or devices adapted to communicate with one another. Further, a program module may be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, GPS and like technologies.

The various technologies described herein may also be implemented in distributed computing environments where tasks are performed by remote processing devices that are linked through a communications network (e.g., by hardwired links, wireless links, or combinations thereof). In a distributed computing environment, program modules may be located in both local and remote computer storage media including memory storage devices.

The system 300 may include a computing device or system 318 (e.g., mobile media device) into which implementations of various technologies and techniques described herein may be implemented. Computing device 318 may be a conventional desktop, a handheld device, a wearable device, a controller, a personal digital assistant, a server computer, an electronic device/instrument, a laptop, a tablet, or part of a navigation system, marine electronics, or sonar system. It should be noted, however, that other computer system configurations may be used.

In various implementations, each marine electronic device 302 described herein may be referred to as a marine device or as an MFD. The marine electronic device 302 may include one or more components disposed at various locations on a marine vessel. Such components may include one or more data modules, sensors, instrumentation, and/or any other devices known to those skilled in the art that may transmit various types of data to the marine electronic device 302 for processing and/or display. The various types of data transmitted to the marine electronic device 302 may include marine electronics data and/or other data types known to those skilled in the art. The marine data received from the marine electronic device 302 or system 300 may include chart data, sonar data, structure data, radar data, navigation data, position data, heading data, automatic identification system (AIS) data, Doppler data, speed data, course data, or any other type known to those skilled in the art.

In one implementation, the marine electronic device 302 may include a radar sensor for recording the radar data and/or the Doppler data, a compass heading sensor for recording the heading data, and a position sensor for recording the position data. In another implementation, the marine electronic device 302 may include an AIS transponder for recording the AIS data, a paddlewheel sensor for recording the speed data, and/or the like.

The marine electronic device 302 may receive external data via a LAN or a WAN. In some implementations, external data may relate to information not available from various marine electronics systems. The external data may be retrieved from various sources, such as, e.g., the Internet or any other source. The external data may include atmospheric temperature, atmospheric pressure, tidal data, weather, temperature, moon phase, sunrise, sunset, water levels, historic fishing data, and/or various other fishing and/or trolling related data and information.

The marine electronic device 302 may be attached to various buses and/or networks, such as a National Marine Electronics Association (NMEA) bus or network, for example. The marine electronic device 302 may send or receive data to or from another device attached to the NMEA 2000 bus. For instance, the marine electronic device 302 may transmit commands and receive data from a motor or a sensor using an NMEA 2000 bus. In some implementations, the marine electronic device 302 may be capable of steering a marine vessel and controlling the speed of the marine vessel (e.g., autopilot). For instance, one or more waypoints may be input to the marine electronic device 302, and the marine electronic device 302 may be configured to steer the marine vessel to the one or more waypoints. Further, the marine electronic device 302 may be configured to transmit and/or receive NMEA 2000 compliant messages, messages in a proprietary format that do not interfere with NMEA 2000 compliant messages or devices, and/or messages in any other format. In various other implementations, the marine electronic device 302 may be attached to various other communication buses and/or networks configured to use various other types of protocols that may be accessed via, e.g., NMEA 2000, NMEA 0183, Ethernet, Proprietary wired protocol, etc. In some implementations, the marine electronic device 302 may communicate with various other devices on the marine vessel via wireless communication channels and/or protocols.

In some implementations, the marine electronic device 302 may be connected to a global positioning system (GPS) receiver. The marine electronic device 302 and/or the GPS receiver may be connected via a network interface. In this instance, the GPS receiver may be used to determine position and coordinate data for a marine vessel on which the marine electronic device 302 is disposed. In some instances, the GPS receiver may transmit position coordinate data to the marine electronic device 302. In various other instances, any type of known positioning system may be used to determine and/or provide position coordinate data to/for the marine electronic device 302.

The marine electronic device 302 may be configured as a computing system similar to computing device 318.

### Example Flowchart(s)

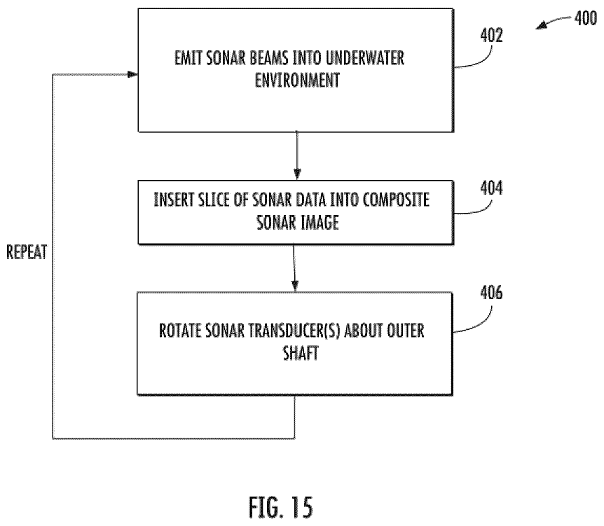

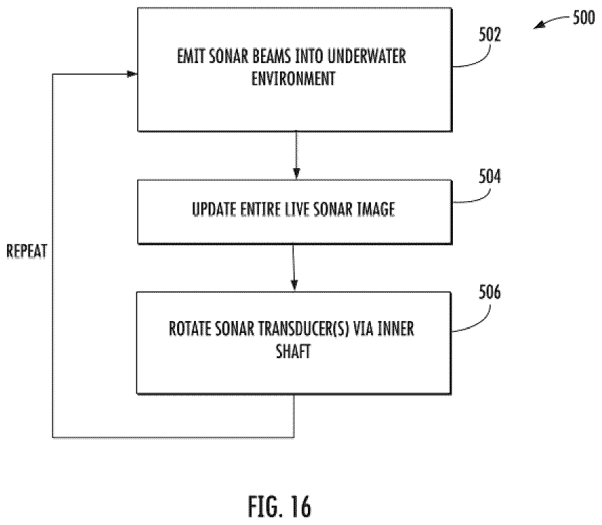

Embodiments of the present disclosure provide methods for controlling a watercraft. Various examples of the operations performed in accordance with embodiments of the present disclosure will now be provided with reference to FIGS. 15-16.

FIG. 15 illustrates a flowchart according to an example method 400 for forming a 360-degree sonar image, according to various example embodiments described herein. The operations illustrated in and described with respect to FIG. 15 may, for example, be performed by, with the assistance of, and/or under the control of one or more of the components described herein, e.g., in relation to system 300.

Operation 402 may comprise emitting sonar beams into an underwater environment. In some embodiments, for example, operation 402 may include emitting sonar beams from one or more linear, conical, and/or square transducer elements that are, e.g., aligned such that beam coverage is capable of achieving 360-degree coverage (with or without periodic movement of the transducer elements). The components discussed above with respect to system 300 may, for example, provide means for performing operation 402.

Operation 404 may include inserting a slice of sonar data into a composite sonar image. For example, operation 404 may include obtaining a portion of sonar data corresponding to a portion of an underwater environment, using that portion of sonar data to for a slice of a 360-degree sonar image, and then inserting that slice of the 360-degree sonar image into the appropriate position within the 360-degree sonar image. For example, a process similar to the process shown and described with respect to FIG. 9 may be used for operation 404. The components discussed above with respect to system 300 may, for example, provide means for performing operation 404.

Operation 406 may include rotating the sonar transducer element(s) about an outer shaft of a sonar device assembly. For example, rotating the sonar transducer element(s) as part of operation 406 may cause the method 400 to, when repeated, obtain different slices of the composite 360-degree sonar image such that, upon the method 400 repeating a certain number of times, the entire composite 360-degree image is formed and/or updated. The components discussed above with respect to system 300 may, for example, provide means for performing operation 406.

FIG. 16 illustrates a flowchart according to an example method 500 for forming and updating a live sonar image, according to various example embodiments described herein. The operations illustrated in and described with respect to FIG. 10 may, for example, be performed by, with the assistance of, and/or under the control of one or more of the components described herein, e.g., in relation to system 300.

Operation 502 may include emitting sonar beams into an underwater environment. In some embodiments, for example, operation 502 may include emitting sonar beams from one or more transducer arrays that are, e.g., aligned such that beam coverage is capable of achieving high-definition live sonar data. The components discussed above with respect to system 300 may, for example, provide means for performing operation 502.

Operation 504 may include forming or updating an entire live sonar image using the sonar data obtain from the transducer array(s). The components discussed above with respect to system 300 may, for example, provide means for performing operation 504.

Operation 506 may include rotating the sonar transducer array(s) via an inner shaft of a sonar device assembly of an assembly. For example, rotating the sonar transducer array(s) as part of operation 506 may cause the method 500 to, when repeated, obtain a view of a different portion of the underwater environment. The rotation may be initiated by a user or an autopilot navigation assembly to optimize which portion of the underwater environment is shown in the live sonar images obtained using the method 500. Repetition of method 500 may ensure that the live sonar image accurately reflects the reality of the underwater environment at the time the live sonar image is viewed by the user. The components discussed above with respect to system 300 may, for example, provide means for performing operation 506. Operation 506 may be optional.

FIGS. 15-16 illustrate flowcharts of systems, methods, and/or computer program products according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 312, and executed by, for example, the processor 304. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

In some embodiments, the methods described above may include additional, optional operations, and/or the operations described above may be modified or augmented.

### Conclusion

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A system for a watercraft, the system comprising:
an elongated shaft defining an axis;
a 360-degree sonar imaging device attached to the shaft, wherein the sonar imaging device comprises at least one sonar transducer element, wherein the sonar imaging device comprises a housing and the at least one sonar transducer element is positioned within the housing; and
a motor within the housing and operable to cause the at least one sonar transducer element to at least partially rotate about the axis to adjust a facing direction thereof relative to the axis to enable receipt of sonar returns to be obtained from the at least one sonar transducer element for formation of a 360-degree sonar image,
wherein the motor and the at least one sonar transducer element are mounted offset from the axis of the shaft and wherein the housing defines an annular opening about the axis and sized to enable either the shaft or a second shaft to pass therethrough while still allowing the 360-degree sonar imaging device to be operable.

2. The system of claim 1, wherein the 360-degree sonar imaging device comprises at least three linear sonar transducer elements.

3. The system of claim 2, wherein a conical or square transducer element is paired with each of the at least three linear sonar transducer elements, and wherein each of the conical or square transducer elements is used to create fish arches for sonar imagery for the linear sonar transducer element with which the conical or square transducer element is paired.

4. The system of claim 2, wherein the motor is operable to cause each linear sonar transducer element to adjust a respective facing direction along an arc of angles about the shaft in a back and forth manner.

5. The system of claim 4, wherein the motor causes the facing direction of each linear sonar transducer element of the 360-degree sonar imaging device to adjust between a 0-degree reference point and a point that is 120 degrees from the 0-degree reference point.

6. The system of claim 1, wherein the housing defines a first portion and a second portion, wherein the motor is operable to cause rotation of the first portion of the housing relative to the second portion, and wherein the at least one sonar transducer element is mounted in the first portion of the housing.

7. The system of claim 1, wherein the housing of the 360-degree sonar imaging device is attached circumferentially around the shaft.

8. The system of claim 1 further comprising the second shaft, wherein the second shaft is disposed within the shaft and is rotatable with respect to the shaft.

9. The system of claim 1, wherein the shaft and the 360-degree sonar imaging device are configured to be stowable in the watercraft together and are configured to be deployable from the watercraft together.

10. The system of claim 1, wherein a trolling motor system is at least partially connected to the shaft via one or more support arms.

11. The system of claim 10, wherein a trolling motor shaft corresponding to a trolling motor of the trolling motor system and the shaft are configured to rotate independently of each other.

12. A 360-degree sonar imaging device, wherein the sonar imaging device comprises:
a housing defining an axis;
at least one sonar transducer element positioned within the housing; and
a motor within the housing and operable to cause the at least one sonar transducer element to at least partially rotate about the axis to adjust a facing direction thereof relative to the axis to enable receipt of sonar returns to be obtained from the at least one sonar transducer element for formation of a 360-degree sonar image,
wherein the motor and the at least one sonar transducer element are mounted offset from the axis and wherein the housing defines an annular opening about the axis and sized to enable either a shaft to pass therethrough while still allowing the 360-degree sonar imaging device to be operable.

13. The device of claim 12, wherein the housing defines a first portion and a second portion, wherein the motor is operable to cause rotation of the first portion of the housing relative to the second portion, and wherein the at least one sonar transducer element is mounted in the first portion of the housing.

14. A system for a watercraft, the system comprising:
an elongated shaft defining an axis;
a 360-degree sonar imaging device attached to the shaft, wherein the sonar imaging device comprises at least three sonar transducer elements, wherein the sonar imaging device comprises a housing and the at least three sonar transducer elements are positioned within the housing, wherein the housing defines a first portion and a second portion; and
a motor within the housing and operable to cause the at least three sonar transducer elements to at least partially rotate about the axis to adjust a facing direction thereof relative to the axis to enable receipt of sonar returns to be obtained from the at least three sonar transducer elements for formation of a 360-degree sonar image,
wherein the motor is operable to cause rotation of the first portion of the housing relative to the second portion, and wherein the at least three sonar transducer elements are mounted in the first portion of the housing.

15. The system of claim 14, wherein a conical or square transducer element is paired with each of the at least three sonar transducer elements, and wherein each of the conical or square transducer elements is used to create fish arches for sonar imagery for the sonar transducer element with which the conical or square transducer element is paired.

16. The system of claim 14, wherein the motor causes the facing direction of each sonar transducer element of the 360-degree sonar imaging device to adjust between a 0-degree reference point and a point that is 120 degrees from the 0-degree reference point.

17. The system of claim 14, wherein the housing of the 360-degree sonar imaging device is attached circumferentially around the shaft.

18. The system of claim 14, wherein the shaft and the 360-degree sonar imaging device are configured to be stowable in the watercraft together and are configured to be deployable from the watercraft together.

19. The system of claim 14, wherein a trolling motor system is at least partially connected to the shaft via one or more support arms.

20. The system of claim 19, wherein a trolling motor shaft corresponding to a trolling motor of the trolling motor system and the shaft are configured to rotate independently of each other.
